(19) United States
(12) Patent Application Publication
(10) Pub. No.: US 2011/0184985 A1
(43) Pub. Date: Jul. 28, 2011

(54) METHOD AND SYSTEM FOR IMPLEMENTING AND MANAGING AN ENTERPRISE IDENTITY MANAGEMENT FOR DISTRIBUTED SECURITY IN A COMPUTER SYSTEM

(75) Inventor: Fred Bishop, Glendale, AZ (US)

(73) Assignee: American Express Travel Related Services Company, Inc., New York, NY (US)

(21) Appl. No.: 13/080,473

(22) Filed: Apr. 5, 2011

Related U.S. Application Data
(63) Continuation of application No. 13/079,666, filed on Apr. 4, 2011.
Application No. 13/079,666 is a continuation-in-part of application No. 12/692,817, filed on Jan. 25, 2010.
Application No. 12/692,817 is a continuation of application No. 10/716,251, filed on Nov. 17, 2003, now Pat. No. 7,660,795.
Application No. 10/716,251 is a continuation-in-part of application No. 10/334,271, filed on Dec. 31, 2002, now Pat. No. 7,143,095.

(51) Int. Cl. G06F 17/30

(52) U.S. Cl. 707/783; 707/E17.005

(57) ABSTRACT

A method and system for facilitating the management of user identities includes an ownership component, a registration component, and a servicing component. When a user first desires to access a system using the present invention, the registration component verifies the user's ownership of the underlying account by asking a variety of questions. Thereafter, when a user desires to service his account, the user may be re-queried to determine if he is attempting to access the correct information. An authentication and access component provides the functionality to access a system of the present invention. An audit component can be configured to periodically monitor the various accounts to ensure a continued linking between users and accounts.

### CROSS-REFERENCE TO RELATED APPLICATIONS

This application is a Continuation of U.S. Ser. No. 13/079,666, entitled “Method and System for Implementing and Managing an Enterprise Identity Management for Distributed Security in a Computer System,” filed Apr. 4, 2011. The '666 application is a Continuation in Part of U.S. Ser. No. 12/692,817, entitled “Method and System for Implementing and Managing an Enterprise Identity Management for Distributed Security in a Computer System,” filed Jan. 25, 2010. The '817 application is a Continuation of U.S. Pat. No. 7,660,795 issued on Feb. 9, 2010 (aka U.S. Ser. No. 10/716,251 entitled “Method and System for Implementing and Managing an Enterprise Identity Management for Distributed Security in a Computer System” filed on Nov. 17, 2003). The '795 patent is a Continuation-in-Part of U.S. Pat. No. 7,143,095 issued on Nov. 28, 2006 (aka U.S. Ser. No. 10/334,271 “Method And System For Implementing And Managing An Enterprise Identity Management For Distributed Security,” filed on Dec. 31, 2002). The entire contents of all of these applications are hereby incorporated by reference.

### FIELD OF INVENTION

This application generally relates to computer systems, and more particularly, to a method and system for managing user identities in a computer system.

### BACKGROUND OF THE INVENTION

Computer systems have evolved to the point where it is possible for a user to remotely access personal information via a computer. For example, one can monitor account balances, purchase securities, purchase goods, check the status of goods, and the like, through the use of a personal computer by using, for example, a web browser connected to the Internet.

In providing services such as those listed above, it is desirable that certain types of information be accessible only by authorized users. For example, only the account holder should be able to access information regarding his bank account, be able to perform certain activities (e.g., transfers and withdrawals) on said bank account, or be able to purchase goods using funds from said bank account.

In the past, such security has typically been provided in the form of the combination of a user id and a password. For example, an account at a bank may be protected by having a user “log in” to a banking application by providing a user id and password. However, such a security system may not provide as much security as desired. For example, if an unauthorized person were to become aware of the user id and password, the unauthorized person would then be able to access information and perform tasks that should be limited to a select group of authorized users.

There are several other problems with the above-described scenario. The association between a user ID and an account may become broken. For example, a user named John Smith may select, as a user ID, JSMITH1 and an associated password for use with a bank account. Another person named Joe Smith may select, as a user ID, JSMITH2 and an associated password for use with a different account. After a few months of non-use, Joe Smith attempts to login to his brokerage account. Not remembering his user ID, he thinks his user ID is JSMITH1. After several unsuccessful log-in attempts, he contacts a customer service representative.

In the prior art, the typical method of customer service verifying the user would be to verify ownership of the account. After verifying several pieces of information with Joe Smith (e.g., social security number, mailing address, etc.), the customer service representative is convinced that Joe Smith is who he says he is and grants him access to his brokerage account using the name JSMITH1. When John Smith later tries to login, the same scenario may occur, as John Smith is no longer able to use the JSMITH1 name that he established and contacts customer service to change the password. The result is that the JSMITH1 user ID becomes associated with both the accounts of John Smith and Joe Smith and customer service needs to intervene in order to grant the users their desired authorization level.

Thus, no sufficient system exists that accurately associates customer relationship and validates the continuing integrity of the customer relationship. In particular, the prior art is solely concerned with verifying the ownership of the account, and not verifying the relationship between the user ID and the account. It is desirable to have a more robust method of managing user identities in a computerized system.

### SUMMARY OF THE INVENTION

A system, method, and computer program product for managing identities is described. The method may comprise assigning a positive weight to a first transaction initiated by an identity associated with an account and from a location consistent with a location associated with a previous transaction; assigning a negative weight to a second transaction initiated by the identity associated with the account and from a location inconsistent with the location associated with the previous transaction; and determining a likelihood that the identity owns the account based upon the positive weight and the negative weight.

The method may further comprise assigning a positive weight to a first transaction initiated by an identity associated with an account and from a device consistent with a device associated with a previous transaction; assigning a negative weight to a second transaction initiated by the identity associated with the account and from a device inconsistent with the device associated with the previous transaction; and determining a likelihood that the identity owns the account based upon the positive weight and the negative weight.

The method may further comprise assigning a positive weight to a first transaction initiated at a first time by an identity associated with an account; assigning a negative weight to a second transaction initiated at a second time by the identity associated with the account; and determining a likelihood that the identity owns the account based upon the positive weight and the negative weight.

The method may further comprise comparing a first transaction to a second transaction; assigning one of a positive weight and a negative weight to the comparison based upon the order in which the first transaction and the second transaction occur; and determining a likelihood that an identity owns an account associated with the first transaction and the second transaction based upon the positive or negative weight.

The method may further comprise comparing a transaction to a pattern of transactions; assigning one of a positive weight and a negative weight to the comparison; and determining a likelihood that an identity owns an account associated with the transaction based upon the positive weight or the negative weight.

The method may further comprise generating a pattern associated with a group of transaction amounts indicative of a spending pattern; comparing the pattern to a transaction amount; assigning one of a positive weight and a negative weight to the comparison; and determining a likelihood that an identity owns an account associated with the transaction based upon the positive weight or the negative weight.

The method may further comprise generating a pattern associated with at least one of: a group of withdrawals, inquiries, and deposits; comparing, by the computer-based system, the pattern to a transaction; assigning, one of a positive weight and a negative weight to the comparison; and determining a likelihood that an identity owns an account associated with the transaction based upon the positive weight or the negative weight.

The method may further comprise assigning a positive weight to a successful transaction initiated by an identity associated with an account; assigning a negative weight to an unsuccessful transaction initiated by the identity associated with the account; determining a likelihood that the identity owns the account based upon the positive weight and the negative weight; and posing a question to a user at least one of periodically and in response to assigning a negative weight to an unsuccessful transaction to verify that the user is the owner of the identity.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 presents a block diagram overview of an embodiment;

FIG. 2 is a flowchart illustrating an exemplary process by which a user may create a user ID; and

FIG. 3 shows a flowchart depicting an exemplary method for assigning positive and negative weights to transactions.

### DETAILED DESCRIPTION

The present disclosure may be described herein in terms of various functional components and various processing steps. It should be appreciated that such functional components may be realized by a variety of different hardware or structural components configured to perform the specified functions. For purposes of illustration only, exemplary embodiments of the present invention will be described herein. Further, it should be noted that, while various components may be suitably coupled or connected to other components, such connections and couplings may be realized by a direct connection between components, or by a connection through other components and devices.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system of the present invention.

A system may include a host server or other computing systems including a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor, and a plurality of databases, said databases including client data, merchant data, financial institution data and/or like data that could be used in association with the present invention. As those skilled in the art will appreciate, a user's computer will typically include an operating system (e.g., Windows NT, 95/98/2000, Linux, Solaris, etc.) as well as various conventional support software and drivers typically associated with computers. A user's computer may be in a home or business environment with access to a network. In one exemplary embodiment, access is through the Internet through a commercially available web-browser software package. In another exemplary embodiment, access to the system is through a customer service representative, with a user in contact with the customer service representative telephonically. The customer service representative accesses the system through a variety of different manners, including through the Internet and through a restricted-access Intranet.

The term “database” may refer to any type of data organizing mechanism, such as relational databases, hierarchical databases, object-oriented databases, spreadsheets, and/or the like. Common database products that may be used to implement the databases include DB2 by IBM (White Plains, N.Y.), any of the database products available from Oracle Corporation (Redwood Shores, Calif.), Microsoft Access, Microsoft Excel, or SQL Server by Microsoft Corporation (Redmond, Wash.), or any other database product. Database may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example. It should also be understood that a system of the present invention is not limited to a physical implementation of a single repository of information. It is also possible to have multiple repositories of information. The multiple repositories may be linked together in a variety of different manners to create a single logical repository of information.

A data set annotation may also be used for certain types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified merchants are permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one preferred embodiment, the header or trailer is not stored on the transaction device along with the associated issuer-owned data but instead the appropriate action may be taken by providing to the transaction instrument user at the stand-alone device, the appropriate option for the action to be taken. However, the present invention contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

Communication between the parties to the transaction and the system of the present invention is accomplished through any suitable communication means, such as, for example, a telephone network, Intranet, Internet, point of interaction device (point of sale device, personal digital assistant, cellular phone, kiosk, etc.), online communications, off-line communications, wireless communications, transponder communications and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The computer may provide a suitable website or other Internet-based graphical user interface which is accessible by users. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access or SQL Server, Oracle, Sybase, Informix MySQL, Intervase, etc., may be used to provide an ADO-compliant database management system. The term “webpage” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

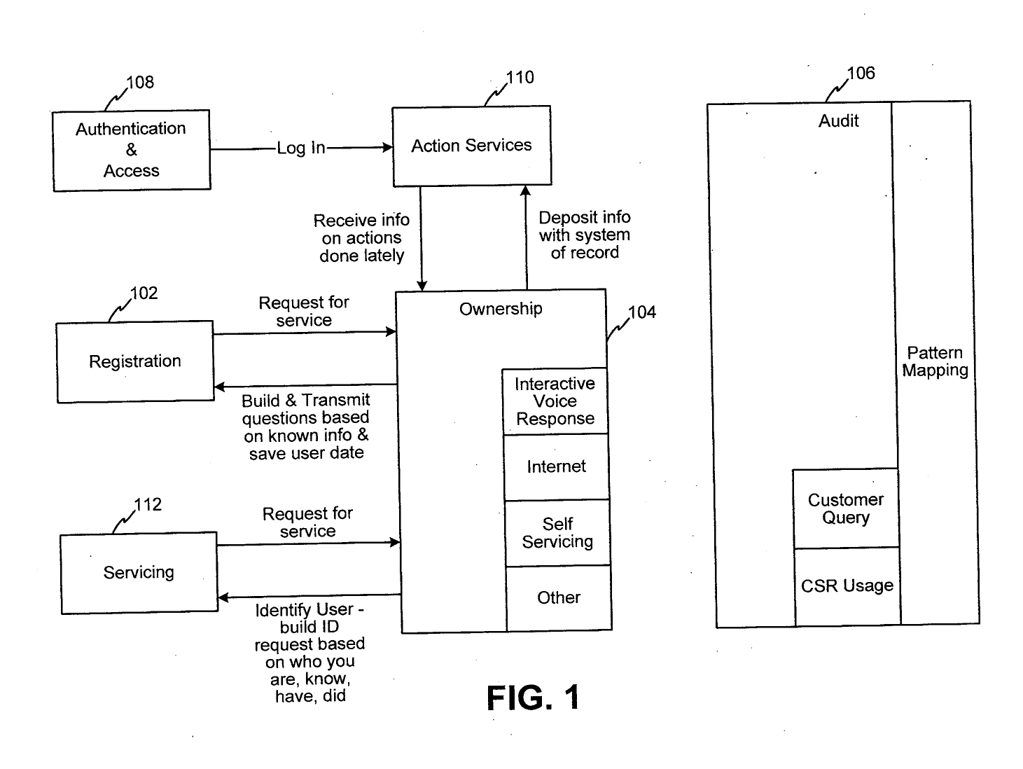

A block diagram illustrating an embodiment of the present invention is illustrated in FIG. 1. A system of the present invention contains, in one embodiment, a registration component (102), an ownership component (104), and an audit component (106). Registration component 102 is configured to facilitate registration of new users and establishing a relationship between the user ID and the account or accounts related to the user ID. Ownership component 104 is configured to facilitate defining the criteria used to verify the ownership of the account. Audit component 106 is configured to facilitate validating the relationships between an account and a user ID on a periodic basis.

A user may initiate a registration process using customer registration component 102. Registration is the process of granting access to various services to a user. For example, one user may wish to be able to track stocks and mutual funds. Another user may wish to perform on-line banking services, such as transfers of money and payment of bills. A different user may wish to access his credit card account to view transactions and pay bills. Other users may wish to perform more than one of the above tasks, and/or other similar tasks.

Registration component 102 is in communication with ownership component 104. When a user requests a registration, ownership component 104 may determine if the user is actually the owner of the account he wishes to access. Such a process may occur by asking various questions of the user, which only the actual owner of the account would be able to answer (as discussed in more detail below). Once the user sufficiently proves that he is the actual owner of the account to ownership component 104, the user may be granted access to the records he desires. Access may be granted based on an identity of the user. An identity may comprise a user ID and password that is issued to the user, and/or biometric data (such as a retina scan, fingerprint, or the like) that is taken of the user and associated with the user. In such a situation, the appropriate biometric reader (e.g., fingerprint scanner, retinal scanner, or the like), may be issued to the user prior to completions of the registration process.

When a user attempts to access his information, authentication and access component 108 may be used to verify the user. To this end, the user will be prompted to enter his user ID and password, and/or the user may be asked to supply biometric data, which may be compared to the biometric data that was supplied at the time of the registration. The action services component 110 may communicate with the authentication and access component 108 and/or the ownership component 104 regarding, for example, actions performed lately and information of record.

In establishing a user ID, a set of criteria may be pre-established to facilitate associating a user ID to an account. In the context of financial services, for example, a financial service provider typically has a large set of data related to each account. In an instance where a user wishes to establish a user ID, registration component 102 has access to subsets of that data through ownership component 104, allowing the establishment of a relationship between a user ID and all accounts owned by the user. For example, if a user wishes to access his bank account on-line, then during the registration process, registration component 102 and ownership component 104 may determine, for example, that the user also owns a brokerage account and a credit account from the same provider of the bank account. Thereafter, an appropriate entry may be made in ownership component 104, noting the relationships between the user ID and the various accounts. Thus, the user ID established by registration component 102 may be associated with the bank account, the brokerage account, and the credit account.

Ownership component 104 may be configured to establish rules to help ensure that adequate ownership information is obtained from a user during authentication. For example, if a user wishes to associate a user ID with a brokerage account, ownership component 104 may be configured to determine criteria (or include a database of predetermined criteria which will be required for certain access requests) to verify that the identity of the person requesting the ID is the owner of the brokerage account. The required criteria may be pre-established, determined based on past access history, determined based on consumer profile data, randomly determined, changed after a certain number of requests and/or the like. Moreover, a user wishing to associate a user ID to another type of account with less need for security (e.g., the ability to check the balance of a credit account) may not utilize the same criteria. For example, access to a brokerage account may require that a user input a name, social security number, date of birth, and verify various information. But access to a balance checking feature may only require a user to know the name, address, and account number associated with an account. Furthermore, access to a securities tracking feature in which no transfer of funds is available, may require even fewer security features.

In addition, this hierarchical registration process can be used to build a relationship over time. For example, a user may register with only the desire to track securities. As time passes, the user decides to register a credit card. Because some of the user's information is already stored by the system in a database, only the additional information needed to access the credit card needs to be obtained from the user. As the user desires more features with higher security, the user is asked more questions to verify the user's identity, without the need to re-ask the previous questions.

For a business organization with multiple business lines, ownership component 104 may be configured to evaluate each business line to determine the authentication process each business line uses. Thereafter, ownership component 104 may use an algorithm to generate or acquire a set of questions or criteria that can be used by registration component 102 to verify that the requesting user is the owner of the account.

Occasionally, a user may wish to modify personal information associated with an account. For example, a user may wish to submit a change of address. In other situations, a user may require the help of a customer service representative (“CSR”) to access his account. Such a situation may occur if a user forgets his user ID or password. In such situations, servicing component 112 may be activated and can interact with the Self Servicing component of the ownership component 104.

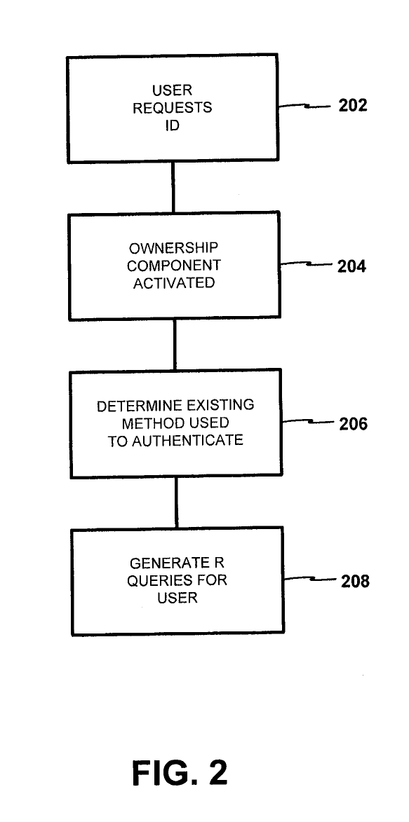

With respect to FIG. 2, an exemplary process by which a user may establish a user ID with a business comprising multiple business lines is illustrated. A user may access a business system and request a user ID (step 202). Such a request may activate registration component 102. Ownership component 104 may determine which accounts from the various businesses are to be associated with the user ID. The user may select the various business lines he wishes to be associated with the user ID. Such a selection can be done by first displaying the eligible business lines, then allowing the user to select (via a graphical user interface) which business lines he wishes to associate with the user ID. Thereafter, ownership component 104 may be activated (step 204). Ownership component 104 may be configured to determine the various schemes used by the selected business lines to authenticate users (step 206). The various authentication processes may be joined in a rules-based algorithm to generate (or acquire from a pre-existing database) specific questions to be asked of the user attempting to obtain a user ID (step 208). In this way, one or more rules-based queries or R queries are generated to be asked of the user. The user supplies the answers to the questions in order further verify his identity as the owner of the account he is trying to access.

The generating and answering of questions may be a dynamic and interactive process. For example, the user can be asked questions of his profile. Subsequent questions may be generated based upon the answer to previous questions. A certain number of correct (or substantially correct) answers may result in a confirmation of the identity of the user. An incorrect answer may lead to further questions in an attempt to confirm the identity of the user. In addition, a question being asked may require physical possession of an object. For example, for a credit card account, a user may be asked to supply information located on the card or even be asked to swipe the magnetic stripe of the card into a reader, should a card reader be available. A user may also be asked to activate or transmit information (e.g., from a smart chip, transponder or PDA) as confirmation of the user's identity.

Furthermore, biometric information may be used in addition to or as an alternative or in addition to issuing a user a User ID and password combination to access certain information. Biometric information may include, for example, fingerprints, retina scans, and the like.

As discussed above, the prior art focused on verifying the ownership of the underlying account, ignoring the relationship between a particular user ID/password and an account. The servicing component 112 minimizes or eliminates these problems by verifying both of the above aspects. Servicing component 112 may generate questions based on information stored in ownership component 104. The questions being generated may be based on a user's assigned level of access. As discussed above, different types of accounts may require different levels of access. A user with only access to tracking features may be required to answer fewer questions than a user with access to money transfer capabilities. The questions being asked may be based on who the user is, what the user knows, what the user has, and what the user has done in the past. For example, who the user may include information as to the user's identity, such as the user's name, address, social security number, and the like. What the user knows may include information that only the true user or owner of the account would know. Such information may include the user's mother's maiden name or date of birth, the year of high school graduation, name of a favorite pet, and the like. What the user has may include information contained on a credit card, such as the CID or CVV2 number, biometric information, and the like. What the user has done may include previous tasks performed by the user. For example, the user may be asked where a credit card was last used or an estimate of the last transaction amount. In response to correct answers to the generated questions, servicing component 112 may verify the user and the CSR or the user may be able to change various information regarding the user's card or account.

Even though a set of relationships is robustly validated at the time of the creation of the relationships, the set of relationships can deteriorate over time, for a number of reasons. For example, account expiration, account re-issuance (e.g., due to a stolen credit card), change in marital status (resulting in a no longer valid card that was previously issued to a spouse), change in address, and the like. In order to maintain an accurate management of identities, it is desirable to periodically monitor the relationships.

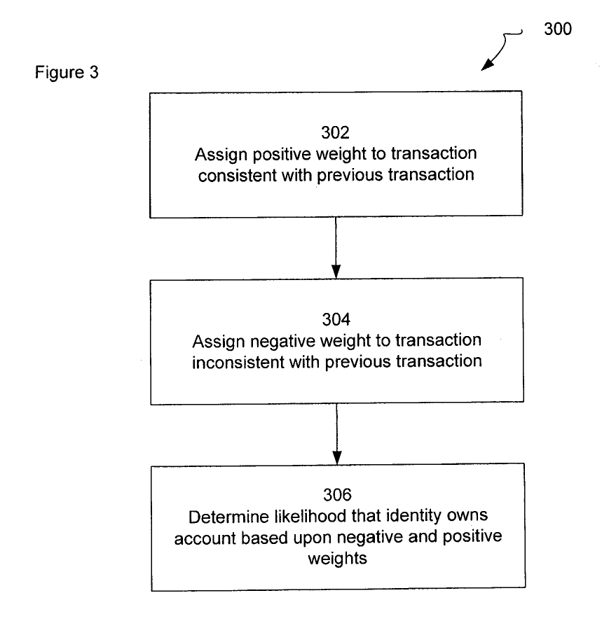

With reference now to FIG. 3, audit component 106 may utilize a mathematical weighting function (summarized by exemplary process 300) to assign values to specific interactions captured by the system. In one embodiment, interactions that serve to confirm the identity of the user may be assigned positive values (step 302). Examples of these types of interactions may include the payment of balances, the receipt of merchandise, and/or similar transactions where it is unlikely that an unauthorized user performed the transaction. Interactions that serve to undermine the identity of the user may be assigned negative values (step 304). Examples of such interactions may include non-payment of bills, requests to receive merchandise at alternate locations, and/or failed attempts to enter a user id/password/biometric information. One or more positively weighted interactions may suggest that fraud or account deterioration is not occurring. Conversely, one or more negatively weighted interactions may suggest that fraud or account deterioration is occurring.

In addition to the examples provided above, a variety of other transactions, interactions and/or usage behaviors may be captured and compared to a typical usage pattern and/or a prior interaction/usage and/or another pertinent criterion or set of criteria. As described above, the result of a comparison may be used to assign a positive or negative weight to the interaction/transaction/usage/comparison (steps 302 and 304). Typical/prior usage may include the tasks performed by the user, the location of the user when accessing the system electronically (which may be determined, for example, via the IP address or addresses from which they typically connect), and/or usage of the underlying account.

Thus, for example, there may be fraud and/or account deterioration if an account is being used or accessed from multiple locations (such as cities, states, countries, etc.) Likewise, there may be fraud and/or account deterioration where an account is used or accessed from multiple internet service providers (ISPs), internet protocol (IP) addresses, browsers, and/or devices (e.g., devices having different media access control (MAC) addresses, personal computers, cell phones, smart phones, PDAs, kiosks, and the like).

The time during which an account is used or accessed may provide further insight into the likelihood or possibility of fraud/account deterioration. For example, an access attempt during the nighttime may present a greater likelihood of fraud than an account that is accessed during the daytime (e.g., morning, afternoon, evening, etc.) Further, consecutive or repeated access attempts may suggest fraud/account deterioration, where, for example, a user attempts to gain access to an account repeatedly over the course of several seconds, minutes, hours, or even days. Further still, the timing of multiple access attempts may be coupled to the location of each access attempt and/or the device from which each access attempt was made in order to detect potentially fraudulent behavior. For example, a first access attempt from location A may be compared to a second access attempt from location B, which is, for instance, several hundred or several thousand miles distant from location A. Although the disparity in location may alone suggest fraud/account deterioration, the timing of each access attempt may be compared, and, where for example, the first attempt was made only seconds or minutes prior to the second attempt, fraud/account deterioration is virtually certain.

Further still, the order in which one or more accounts are accessed, and/or the order in which a user performs operations (e.g., transactions, interactions) on or within an account may be useful in determining whether fraudulent activity/account deterioration are occurring. For example, a user who first attempts to change or changes account information (e.g., a user id, a password, a name, an address, a telephone number, etc.) and next attempts to withdraw funds or close the same or a related account may be engaged in fraud. Likewise, a user who modifies or attempts to modify an account/information associated therewith and next applies for a new or increased line of credit and/or expends substantial existing credit may be engaged in potentially fraudulent or suspicious activity. Thus, the order in which an account or accounts are accessed/modified/utilized may be associated with a positive or negative weighting.

Fraud and/or account deterioration may be further detected by comparing a transaction to a pattern of transactions, where the transaction and pattern of transactions may be associated with one or more accounts (e.g., multiple lines of credit/bank accounts or a single line of credit/bank account). For example, a purchase of an airline ticket with an account which a user typically makes small purchases (e.g., groceries, movie tickets, etc.) may indicate fraudulent activity/deterioration of an account. Likewise, a user who utilizes one or more accounts to purchase from several categories of items (e.g., groceries, electronics, and airline tickets) may be at risk of fraud and/or account deterioration where, for example, one or more of those accounts are used to make a purchase that is uncharacteristic of the customary categories (e.g., a limousine rental). In these and similar circumstances, the comparison may be associated with a negative weighting. A positive weighting, as the reader may well imagine, may be assigned to a comparison that is characteristic of a customary category of purchasing/transaction activity and/or an otherwise characteristic or non-anomalous purchase or transaction.

Similarly, a pattern of regular spending amounts and/or a pattern of inquiries, withdrawals, and/or deposits may reveal fraudulent activity/account deterioration. For instance, a user who uses an account or accounts to make a purchase for an amount that is uncharacteristic of a pattern of amounts may be at risk of fraud/account deterioration. That is, for example, a user who typically uses an account to make purchases of less than $500 or only on weekends may be at risk where a purchase in a greater amount (e.g., $1000) or on a non-weekend is made using the account. Moreover, spending patterns may be associated with groups of items/products. For example, a user may have a first spending pattern for his groceries (i.e., every Sunday and in an amount less than $100 from Trader Joe's) and a second spending pattern for air travel (e.g., typically over Christmas and for several weeks during the summer). A user may be further associated with patterns of inquiry (e.g., a user logs in every Saturday morning to check his account balance), patterns of withdrawal (e.g., a user withdraws funds every Friday in an amount that rarely exceeds $100), and/or patterns of deposit (e.g., a user's employer directly deposits his paycheck on a regular basis). These patterns may be compared to individual activity (e.g., spending, inquiry, withdrawal, and/or deposit), and a positive or negative weighting may be assigned to the comparison as described above. That is, a negative weighting may be assigned to a comparison that reveals activity uncharacteristic of a pattern, and a positive weighting may be assigned to a comparison that reveals activity characteristic of a pattern.

The data described above may be updated at regular intervals. For example, each time the user accesses the system, a similarity score may be computed that indicates the similarity of the transaction to previous transactions, and/or the location and/or device information associated with the access request may be logged. Thus, each usage or interaction establishes or adds to a usage history for a user, and data entries in a usage history may be compared to determine a likelihood of fraud and/or account deterioration (step 306).

Accordingly, a negative weight (and a positive weight, in the reverse scenario) may be assigned to a transaction based on any or all of the foregoing criteria (steps 302 and 304). To summarize, based on the negative and positive weights, a transaction may be flagged as potentially fraudulent or associated with potential account deterioration. (step 306).

In addition to the foregoing, certain interactions may be weighted in aggregate form. In other words, some combinations of events may have relationships with each other. For example, a series of identity-undermining events may have an aggregate negative weighting that exceeds the individual negative weightings described above, or a cumulative negative weighting that exceeds the aggregation or sum of the individual negative weightings in the series of identity-undermining events. Likewise, a series of identity-confirming events may have an aggregate positive weighting that exceeds the individual positive weightings described above, or a cumulative positive weighting that exceeds the aggregation or sum of the individual positive weightings in the series of identity-confirming events.

Positive and negative scores (both in the aggregate an individually) may be changed into a probability score using a variety of different algorithms. For example, a certain number of positive scores combined with a number of negative scores results in a probability score of 95%, indicating a 95% likelihood that the user is who he says he is. The probability score can be combined with the hierarchical scheme of registrations to require different probability scores to access different systems. For example, a probability of 80% may be sufficient to allow access to a securities tracking system, but a probability of 99.99% may be required to allow trading of securities.

The system may increase security by asking specific questions that only a user would know the answer to, prior to allowing the user to perform certain transactions. For example, additional questions may be asked when a user attempts to transfer funds, obtain a cash advance, or other such transactions that have been determined to require more security to perform. Such questions are more specific and would only be known to the user or cardholder, and not to those who, for example, steal a credit card or attempt to fraudulently or accidentally gain access to an account that is not their own. Such a question may include queries regarding previous purchases, questions regarding associated accounts, and the like, in addition to questions regarding the account holder, such as address, social security number, date of birth, somewhere you are, something you've done, and the like. The questions asked can be determined algorithmically using various methods. Correct answers to such questions not only allow the user to perform the requested tasks, but also increase the above-described certainty measure of the user.

Such questions may be asked telephonically. In such a case, it may be desirable to avoid having a human CSR who may possibly be able to steal such information. In such a situation, a voice recognition unit (“VRU”), or interactive voice response (“IVR”) may be used to obtain the answers from the users and translate the answers into a computer-readable form, without the need for additional human assistance. In addition, when a CSR is involved in a servicing process, each of the CSR's activities may be tracked. Such a tracking system can be integrated into a fraud detection system. Such a process can be used to determine if a CSR is involved in identity-theft.

The audit module 106 may include a periodic self-audit of information. To ensure that proper data exists for each user, an audit can be conducted periodically. Such an audit may consist of querying a user as to the user's contact information. The user can confirm or update the information. To ensure that the user is who he says he is, the user may also be required to answer questions, such as those described in more detail above. Such a task ensures that accurate information regarding each user is stored. For example, if a user changes residence, such a fact can be determined by the periodic audit. In one embodiment, the periodic audit may occur annually. Moreover, where an identity is associated with one or more negatively weighted transactions, the audit module 106 may verify the relationship of the identity with the account.

It can thus be seen that the problems of the prior art can be eliminated by an embodiment of the present invention. For example, it would not be possible for the owner of user ID JSMITH2 to obtain access to the user ID JSMITH1, as the servicing component in conjunction with the ownership component would determine that, although he is the owner of an account, he is not the owner of the account associated with the JSMITH1 user ID.

The present invention is described herein with reference to block diagrams, flowchart illustrations of methods, systems, and computer program products according to various aspects of the invention. It will be understood that each functional block of the block diagrams and the flowchart illustrations, and combinations of functional blocks in block diagrams and flowchart illustrations, respectively, may be implemented by computer program instructions. These computer program instructions may be loaded on a general purpose computer, special purpose computer, or other programmable data processing apparatus to produce a machine, such that the instructions which execute on the computer or other programmable data processing apparatus create means for implementing the functions specified in the flowchart block or blocks.

It will be appreciated, that many applications of the present invention could be formulated. One skilled in the art will appreciate that the network may include any system for exchanging data or transacting business, such as the Internet, an intranet, an extranet, WAN, LAN, satellite communications, and/or the like. It is noted that the network may be implemented as other types of networks, such as an interactive television (ITV) network. The users may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows 2000, Windows 98, Windows 95, Mac OS, OS/2, BeOS, Linux, UNIX, Solaris or the like. Moreover, although the invention is frequently described herein as being implemented with TCP/IP communications protocols, it will be readily understood that the invention could also be implemented using IPX, Appletalk, IP-6, NetBIOS, OSI or any number of existing or future protocols. Moreover, the system contemplates the use, sale or distribution of any goods, services or information over any network having similar functionality described herein.

The computing units may be connected with each other via a data communication network. The network may be a public network and assumed to be insecure and open to eavesdroppers. In the illustrated implementation, the network may be embodied as the Internet. In this context, the computers may or may not be connected to the Internet at all times. For instance, the customer computer may employ a modem to occasionally connect to the Internet, whereas the bank-computing center might maintain a permanent connection to the Internet. Specific information related to the protocols, standards, and application software utilized in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference.

These computer program instructions may also be stored in a computer-readable memory such as a computer readable storage medium that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded on a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In the foregoing specification, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention.

Benefits, other advantages, and solutions to problems have been described above with regard to specific embodiments. No element described herein is required for the practice of the invention unless expressly described as “essential” or “critical”.

What is claimed is:

1. A method comprising:
assigning, by a computer-based system for identity management, a positive weight to a first transaction initiated at a first time by an identity associated with an account;
assigning, by the computer-based system, a negative weight to a second transaction initiated at a second time by the identity associated with the account; and
determining, by the computer-based system, a likelihood that the identity owns the account based upon the positive weight and the negative weight.

2. The method of claim 1, further comprising aggregating, by the computer-based system, a plurality of positive weights and a plurality of negative weights to determine a usage history of a user.

3. The method of claim 1, wherein the determining a likelihood further comprises converting, by the computer-based system, the positive weight and the negative weight to a probability score.

4. The method of claim 1, wherein the first time is at least one of morning, afternoon, and evening, and wherein the second time is nighttime.

5. The method of claim 1, further comprising allowing, by the computer-based system, the identity to access a first account in a hierarchy of accounts based upon a probability score that is lower than a probability score required to access a second account in the hierarchy of accounts.

6. The method of claim 1, further comprising assigning, by the computer-based system, a cumulative negative weight to a series of transactions initiated by the identity associated with the account that occur at times inconsistent with the first time, wherein the cumulative negative weight exceeds the aggregate of each negative weight associated with each transaction in the series of transactions.

7. The method of claim 1, further comprising comparing, by the computer-based system, the first time to the second time, and assigning, by the computer-based system, a negative weight to the comparison based upon a difference between the first time and the second time that exceeds a threshold.

8. An article of manufacture including a non-transitory, tangible computer readable medium having instructions stored thereon that, in response to execution by a computer-based system for identity management, cause the computer-based system to perform operations comprising:
assigning, by the computer-based system, a positive weight to a first transaction initiated at a first time by an identity associated with an account;
assigning, by the computer-based system, a negative weight to a second transaction initiated at a second time by the identity associated with the account; and
determining, by the computer-based system, a likelihood that the identity owns the account based upon the positive weight and the negative weight.

9. The article of claim 8, further comprising aggregating, by the computer-based system, a plurality of positive weights and a plurality of negative weights to determine a usage history of a user.

10. The article of claim 8, wherein the determining a likelihood further comprises converting, by the computer-based system, the positive weight and the negative weight to a probability score.

11. The article of claim 8, wherein the first time is at least one of morning, afternoon, and evening, and wherein the second time is nighttime.

12. The article of claim 8, further comprising allowing, by the computer-based system, the identity to access a first account in a hierarchy of accounts based upon a probability score that is lower than a probability score required to access a second account in the hierarchy of accounts.

13. The article of claim 8, further comprising assigning, by the computer-based system, a cumulative negative weight to a series of transactions initiated by the identity associated with the account that occur at times inconsistent with the first time, wherein the cumulative negative weight exceeds the aggregate of each negative weight associated with each transaction in the series of transactions.

14. The article of claim 8, further comprising comparing, by the computer-based system, the first time to the second time, and assigning, by the computer-based system, a negative weight to the comparison based upon a difference between the first time and the second time that exceeds a threshold.

15. A system comprising:
a processor for identity management,
a tangible, non-transitory memory configured to communicate with the processor,
the tangible, non-transitory memory having instructions stored thereon that, in response to execution by the processor, cause the processor to perform operations comprising:
assigning, by the processor, a positive weight to a first transaction initiated at a first time by an identity associated with an account;
assigning, by the processor, a negative weight to a second transaction initiated at a second time by the identity associated with the account; and
determining, by the processor, a likelihood that the identity owns the account based upon the positive weight and the negative weight.

16. The system of claim 15, further comprising aggregating, by the processor, a plurality of positive weights and a plurality of negative weights to determine a usage history of a user.

17. The system of claim 15, wherein the determining a likelihood further comprises converting, by the processor, the positive weight and the negative weight to a probability score.

18. The system of claim 15, wherein the first time is at least one of morning, afternoon, and evening, and wherein the second time is nighttime.

19. The system of claim 15, further comprising allowing, by the processor, the identity to access a first account in a hierarchy of accounts based upon a probability score that is lower than a probability score required to access a second account in the hierarchy of accounts.

20. The system of claim 15, further comprising comparing, by the processor, the first time to the second time, and assigning, by the computer-based system, a negative weight to the comparison based upon a difference between the first time and the second time that exceeds a threshold.
